(19) United States
(12) Patent Application Publication
(10) Pub. No.: US 2012/0011804 A1
(43) Pub. Date: Jan. 19, 2012

(54) COMPOSITE POLES

(76) Inventors: Michael Winterhalter, Dana Point, CA (US); Martin Wang, Irvine, CA (US)

(21) Appl. No.: 13/079,686

(22) Filed: Apr. 4, 2011

Related U.S. Application Data
(60) Provisional application No. 61/365,634, filed on Jul. 19, 2010.

(51) Int. Cl. E04C 3/29; B23P 17/00

(52) U.S. Cl. 52/834; 29/419.1

(57) ABSTRACT

Poles for supporting electric transmission lines and a method for forming such poles are provided. An exemplary pole includes a center shaft and a first modular support shaft. The first modular support shaft surrounds more or less of the length of the center shaft and includes a plurality of first panels.

### CROSS-REFERENCE TO RELATED APPLICATION

This application is based upon and claims priority on U.S. Provisional Patent Application No. 61/365,634, filed on Jul. 19, 2010, the contents of which are fully incorporated herein by reference.

### FIELD OF THE INVENTION

The present invention relates generally to the field of power poles for the support and travel of electrical conductor cables designed to transmit electrical power.

### BACKGROUND OF THE INVENTION

Electric transmission lines are the life-lines of a country's economy. Transmission lines interconnecting giant load centers with distant generation sources are vital to redistribute electrical power as required.

It is known to use treated wood poles to form transmission poles. However, chemicals used to treat wood poles have been found to contain carcinogens. Environmental and economic concerns stemming from the special disposal of treated wood poles have led to the search for alternatives to wood.

Concrete and steel are also used to form power poles. However, the weight of these materials makes cost of transport and installation excessive. Moreover, steel is highly conductive, while concrete structures expand and contract with temperature causing vertical cracking.

Resistance to corrosion is an additional common concern when using power poles. The ground in which the pole is placed, as well as the surrounding environment, can cause the pole to corrode, decreasing pole strength and pole life.

Cost of power pole manufacture is an additional concern. This cost results from materials used, scrap, waste, time of manufacture, and labor. It is therefore desirable to provide a power pole that can be inexpensively manufactured and transported and that is structurally sound and environmentally safe while being resistant to corrosion and environmental factors such as wind, moisture, heat, cold, etc.

There has been a great demand for composite power poles due to their relatively light weight, resistance to corrosion, and non-conductivity. Furthermore, composite materials generally use ecologically friendly manufacturing methods, especially when compared to steel power poles. However, the cost of composite materials on a cost per weight basis tends to be higher than traditional materials. Single wall composite structures are generally not sufficiently strong for power pole applications, and thus, often require additional support, such as a foam core. However, this results in added cost and can cause long term difficulty. Other designs have focused on tapered structures, however, such structures are not easily made using traditional composite power pole manufacturing processes, and thus may add significant cost.

### SUMMARY OF THE INVENTION

A composite pole for supporting an electric transmission line is provided. In an exemplary embodiment, the composite pole includes a center shaft, and a first modular support shaft, the first modular support shaft including a plurality of first panels. In another exemplary embodiment, the center shaft has a plurality of center indentations, and each of the plurality of first panels has a first protrusion on a first side and a first indentation on a second side, and the first protrusion is configured to nest with one of the center indentations. In yet another exemplary embodiment, the pole further includes a second modular support shaft, the second support including a plurality of second panels, each of the plurality of second panels having a second protrusion on a first side, the second protrusion being configured to nest with the first indentation. In one exemplary embodiment, the first modular support shaft spans less than a length of the center shaft. In another exemplary embodiment, it spans more than the length of the center shaft. In a further exemplary embodiment, the pole further includes a second modular support shaft, the second modular support shaft surrounding less or more than the length of the first modular support shaft, the second module support shaft including a plurality of second panels. In yet a further exemplary embodiment, the center shaft is formed from a first composite material, the first modular support shaft first panels are formed from a second composite material, and the second modular support shaft second panels are formed from a third composite material. In another exemplary embodiment, the first, second and third composite materials are the same material. In yet another exemplary embodiment, at least one of the first, second and third composite materials is different from the other two of the first, second and third composite materials. In a further exemplary embodiment, the first modular support shaft has a circular or elliptical outer surface when viewed in cross-section. In one exemplary embodiment, the shaft may be circular, elliptical or polygonal when viewed in cross-section. In a further exemplary embodiment, the center shaft is hollow and is at least partly filled with a bulking material. In another exemplary embodiment, a reinforcing layer is provided between at least one of the plurality of first panels and at least one of the plurality of the second panels.

In another exemplary embodiment, a method is provided for forming a composite pole for supporting an electric transmission line. The method includes pultruding a first composite material forming a pultruded shaft, pultruding a second composite material forming a plurality of pultruded panels, installing the pultruded shaft into the ground, having a section extending above ground, and installing the plurality of panels to surround the pultruded shaft framing the composite pole. In another exemplary embodiment, each of the plurality of panels has a length that is less than a length of the shaft section extending above ground. In another exemplary embodiment, each of the plurality of panels has a length that is greater than a length of the shaft section extending above ground. In yet another exemplary embodiment, forming the plurality of pultruded panels includes pultruding all of the plurality of pultruded panels simultaneously. In a further exemplary embodiment, foaming the plurality of pultruded panels includes pultruding the second composite material through the same dye for forming all of the plurality of pultruded panels. In yet a further exemplary embodiment, forming the plurality of pultruded panels includes pultruding the second composite material to form a length of pultruded material and cutting the pultruded material at appropriate intervals to form the plurality of panels. In another exemplary embodiment, forming the plurality of panels includes pultruding the second composite material and cutting the pultruded second composite material at an appropriate length to form a first of the plurality of panels. In yet another exemplary embodiment, the method further includes continuing to pultrude the second composite material, and cutting the pultruded material to form a second of the plurality of panels. In a further exemplary embodiment, cutting includes cutting the pultruded second composite material proximate the dye. In another exemplary embodiment, the first and second composite materials are the same and in yet another exemplary embodiment, the first and second composite materials are different. In yet another exemplary embodiment, forming a pultruded shaft includes forming a hollow pultruded shall and the method further includes filling at least part of the hollow pultruded shaft with a bulking material.

### BRIEF DESCRIPTION OF THE DRAWINGS

FIG. 1 is a perspective view of an exemplary power pole assembly;

FIG. 2 is a cross sectional view of an exemplary power pole assembly;

FIG. 3 is a cut-away perspective view of an exemplary power pole assembly;

FIG. 4 is a cross sectional view of an exemplary power pole assembly; and

FIG. 5 is a cross sectional view of another exemplary power pole assembly.

FIG. 6 is a cross-sectional view of yet another exemplary embodiment power pole assembly.

FIG. 7 is a partial cross-sectional view of two panels interfacing with each other via a reinforcing layer.

FIG. 8 is a partial cross-sectional view of two layers interfacing with each other via a reinforcing layer to form the center shaft.

FIG. 9 is a partial exploded view of a coupling element used for coupling two panels along an axis.

### DETAILED DESCRIPTION

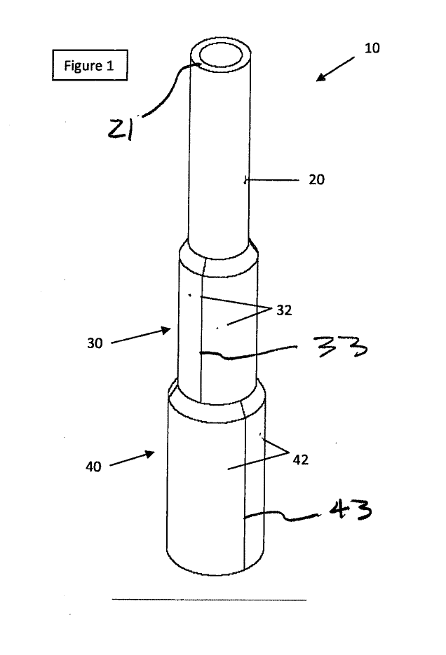

FIG. 1 shows a view of a power pole assembly 10 according to an exemplary embodiment of the invention. As shown, the power pole assembly 10 includes a one-piece center shaft 20, a first modular support shaft 30, and a second modular support shaft 40. In the shown exemplary embodiment, the center shaft 20 is hollow. The first modular support shaft 30 includes a plurality of panels 32. The first modular support shaft 30 surrounds and extends along a portion of the length of the center shaft 20 (i.e., it does not extend the entire length of the center shaft). The first modular support shaft 30 may include any suitable number of panels. For example, the first modular support shaft 30 may include three panels, or it may include six panels. The second modular support shaft 40 includes a plurality of panels 42. The second modular support shaft 40 surrounds and extends along a portion of the length of the first modular support shaft 30. The second modular support shaft 40 may include any suitable number of panels. For example, the second modular support shaft 40 may include three panels, or it may include 6 panels. The second modular support shaft 40 may have the same number of panels as the first modular support shaft 30 or it may have a different number of panels than the first modular support shaft 30. The panels 42 of the second modular support shaft 40 may be larger than the panels 32 of the first modular support shaft 30. In the shown exemplary embodiment, each of the panels 32, 42 are hollow.

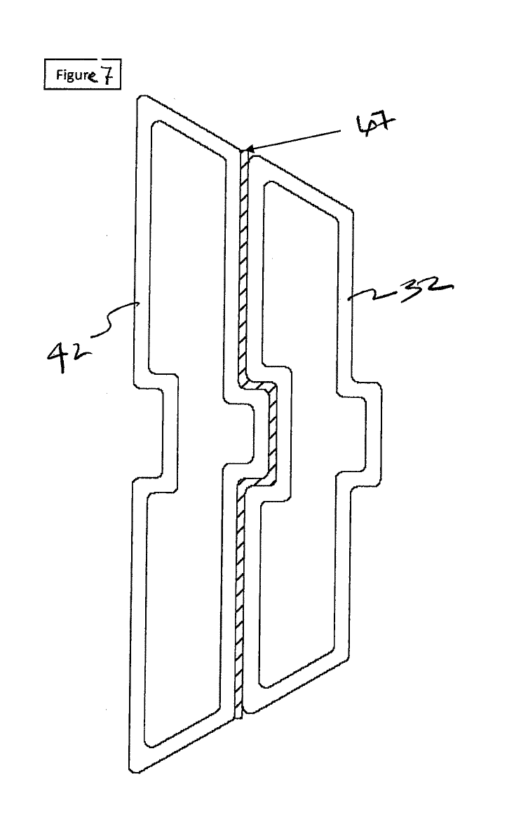

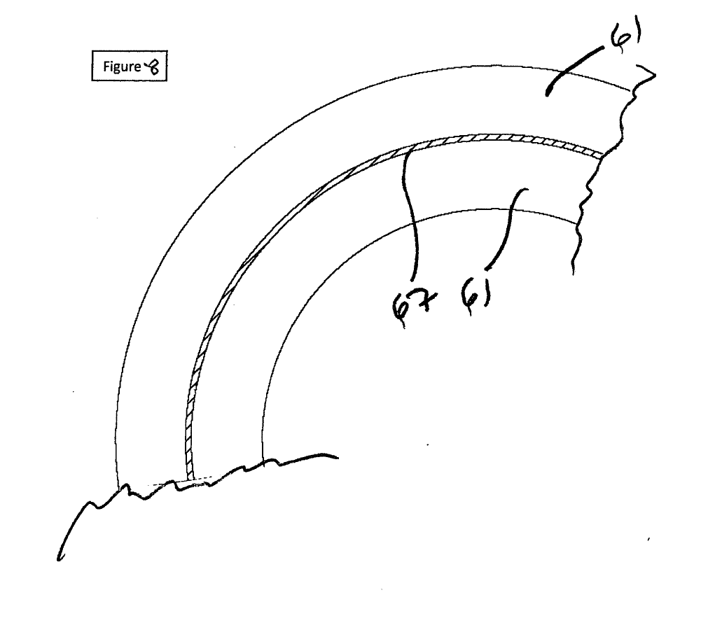

Each of the plurality of panels 32 of the first modular support shaft 30 may be affixed to adjacent panels of the plurality of panels 32. Additionally, each of the plurality of panels 32 of the first modular support shaft 30 may be affixed to the center shaft 20. The plurality of panels 32 may be affixed using an adhesive. However, any suitable method may be used to affix the panels to each other or the underlying shaft. Similarly, each of the plurality of panels 42 of the second modular support shaft 40 may be affixed to adjacent panels of the plurality of panels 42. Additionally, each of the plurality of panels 42 of the second modular support shaft 40 may be affixed to adjacent panels 32 of the first modular support shaft 30. As depicted in FIG. 1, the center shaft 20 and first and second modular support shafts 30 and 40 may be tiered. In other words, a length of the center shaft 20 extends the entire length of each of the first and second modular support shafts 30 and 40 and also extends beyond the length of each of the first and second modular support shafts 30 and 40. Similarly, a length of the first modular support shaft 30 may extend the entire length of the second modular support shaft 40 and also may extend beyond the second modular support shaft 40. A reinforcing layer 67 may be used between adjacent panels from adjacent modular support shafts, as for example between panels 32 and 42 as shown in FIG. 7. In addition a reinforcing layer may be used between the panel(s) of the first modular support shaft and the center shaft. In addition the center shaft may be formed from multiple concentric sections 61 which interface via a reinforcing layer 67, as for example shown in FIG. 8. The reinforcing layers 67 may be adhered to the panels and/or the center shaft and/or center shaft sections. The reinforcing layers may be formed from a composite material designed to provide additional strength and/or stiffness. For example the reinforcing layers may be formed from glass or carbon fiber reinforced composite materials. They may also be formed from foam or balsa.

While only two modular support shafts are depicted in FIG. 1, any suitable number of modular support shafts could be used. For instance, for shorter poles with relatively low loads, only one modular support shaft may be necessary. In other instances, it may be desirable to create much taller poles that can withstand greater loads, and accordingly, multiple modular support shafts may be used.

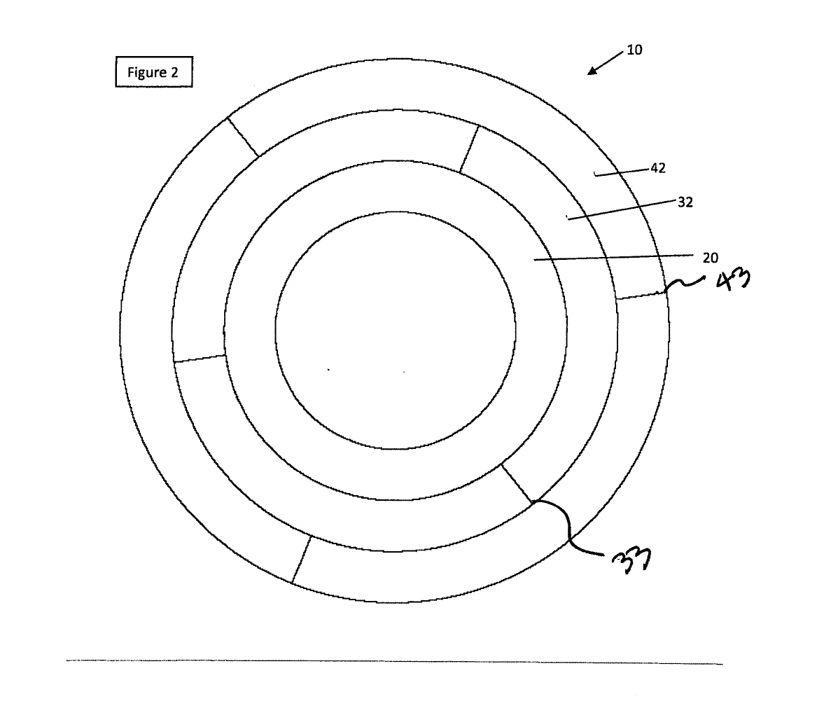

While the panels 32 and 42 may be in line with one another (i.e., a first panel 32 ends 33 are aligned with the ends 43 of a second panel 42) the ends 33, 43 of panels 32 and 42, and thus, the panels 32, 42, may also be offset or staggered, as shown in FIG. 2. By staggering the panels, a power pole assembly 10 may have additional strength. Different strength and bend characteristics may be realized by aligning or staggering the panels.

The power pole assembly 10 may be buried in the ground. In other words, in an exemplary embodiment, each of the center shaft 20, the first modular support shaft 30, and the second modular support shaft 40 may be buried below ground.

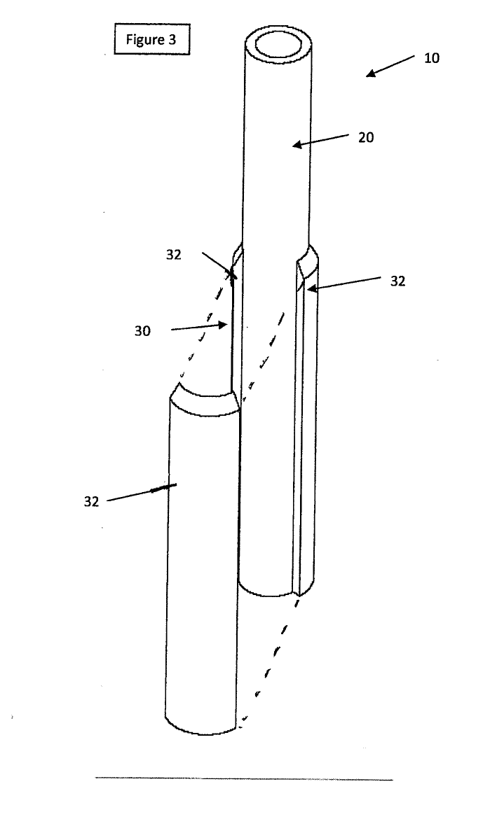

FIG. 3 depicts a cut-away view of a power pole assembly 10 according to an exemplary embodiment of the invention. As shown, the power pole assembly 10 according to an exemplary embodiment of the invention may be modularly constructed. In other words, the center shaft 20 may be installed first. Subsequently, panels of the plurality of panels 32 may be individually installed adjacent to the center shaft 20 to form the first modular support shaft 30. The plurality of panels 32 may be affixed to each adjacent panel and/or may also be affixed to the center shaft 20 as described above. Using the modular panels of embodiments of the present invention, additional modular support shafts may be added using additional panels after an initial completion of a power pole assembly 10. In other words, as needs such as load requirements change, additional support shafts may be easily added to support the power pole assembly. Additionally, by using the modular panels of embodiments of the present invention, transportation of the smaller components may be easier and installation of the assembly may be simplified.

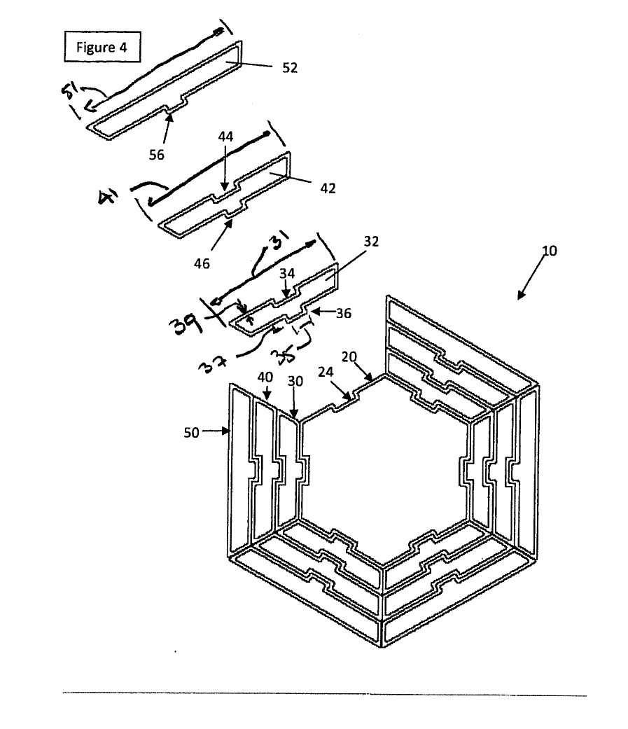

FIG. 4 depicts a cross sectional view of a power pole assembly 10 according to another exemplary embodiment of the invention. As shown, the center shaft 20 may have a hexagonal shape. A width of the hexagonal center shaft 20, from one side to another, in an exemplary embodiment, may be about 1 foot 6 inches. The hexagonal center shaft 20 may have an indentation 24 at each side. Each indentation 24, in an exemplary embodiment, may be about 3 inches wide and about 1 inch deep. The wall thickness of the center shaft 20, in an exemplary embodiment, may be in about 0.125 inch to 1 inch. In another exemplary embodiment, the wall thickness of the center shaft is in the range of about 0.125 inch to 0.5 inch. A panel 32 of a first modular support shaft 30 may have a protrusion 36 designed to nest or mate with the indentation 24 of the center shaft 20. The panel 32, in an exemplary embodiment, may have a width 31, at its widest point in the range of about 6 inches to 14 inches. The protrusion 36, in an exemplary embodiment, may have a width of about 3 inches and a depth of about 1 inch. Similarly, the panel 32 may have an indentation 34. The indentation 34, in an exemplary embodiment, may have a width 35 of about 3 inches and a depth of about 1 inch. The panel, excluding the protrusion 36, in an exemplary embodiment, may have a depth 37 of about 3 inches. The thickness 39 of the walls of the panels 32, in an exemplary embodiment, may be in the range of about 0.625 inch to 0.075 inch. In another exemplary embodiment, the thickness of the panel walls may be about an inch. A panel 42 of a second modular support shaft 40 may have a protrusion 46 designed to nest or mate with the indentation 34 of the panel 32. The panel 42, in an exemplary embodiment, may have a width 41, at its widest point, of about 1 foot 5 inches. Panel 42 may also have an indentation 44. In an exemplary embodiment, the size of the protrusion 46, indentation 44, depth, and thickness of the panel 42 may be similar to that of the panel 32. A panel 52 of a third modular support shaft 50 may have a protrusion 56 designed to nest or mate with the indentation 44 of the panel 42. The panel 52 may have a width 51, in an exemplary embodiment, at its widest point in the range of about 6 inches to 21 inches. In an exemplary embodiment, the size of the protrusion 56, depth, and thickness of the panel 52 may be similar to that of the panel 32. The use of the protrusions and indentations guide the installation of the panels, allowing for a relatively easy and quick build. In addition to the previously described methods of affixing the panels, an adhesive may also be used in the flat sections interfacing with the other flat sections of the other panels and/or in the indentations and protrusions to affix the indentations and protrusions that nest with one another. Additionally, while exemplary embodiments have been described where indentations are in the center shaft and protrusions in the inner surface of panels of the first modular support shaft (and subsequently indentations in the outer surface of each panel and subsequent protrusions in the inner surface of each panel), a power pole may also include protrusions in the center shaft and indentations in the inner surface of the panels of the first modular support shaft, etc. Also, while exemplary sizes and thicknesses have been described, any suitable sizes and thickness may be used depending on the desired size and shape of the power pole.

The center shaft 20 of the present invention may be any suitable shape. For instance, the center shaft 20 may be a polygon or an ellipse. In exemplary embodiments, the center shaft is circular or hexagonal, as depicted in the Figures. When the center shaft is circular, the panels may be crescent shaped. When the center shaft is hexagonal, the panels may be trapezoidal.

Any suitable number of panels may be used for each modular support shaft. For example, if the center shaft is circular, each modular support shaft may include three crescent shaped panels. In other embodiments, if the center shaft is circular, each modular support shaft may include six crescent shaped panels. However, in some embodiments, each modular support shaft may have a different number of panels. In another exemplary embodiment, if the center shaft is hexagonal, each modular support shaft may include six trapezoidal shaped panels. The size of the panels for each successive support shaft may become increasing larger in order to surround the circumference of the underlying support shaft. While the shown exemplary embodiments depict similar shapes for the center shaft and each modular support shaft (i.e., when the center shaft is a hexagon, the assembled first modular support shaft and all subsequent modular support shafts are also hexagons), the outer shape of the first and/or subsequent modular support shafts may be different than the underlying shape. While the inner surface of each modular support shaft may mate with the outer surface of the underlying modular support shaft or center shaft, the outer surface may be any shape. For instance, in an exemplary embodiment, the center shaft may be hexagonal and the first modular support shaft may have an inner surface that corresponds to the hexagonal shape of the center shaft, but an outer surface that is circular.

In order to reduce weight and cost, each of the panels and the center shaft may be hollow. Hardware, electrical and/or fiber optic cables may be passed through the hollow center shaft or through any of the panels forming the surrounding panels or shafts. In exemplary embodiments, the center shaft and the panels may be filled with a material, such as foam, or other bulking materials to help provide structural support for the power pole assembly. However, foam filling may not be necessary to provide sufficient structural support for the power pole assembly when sufficient modular support shafts are used according to embodiments of the invention.

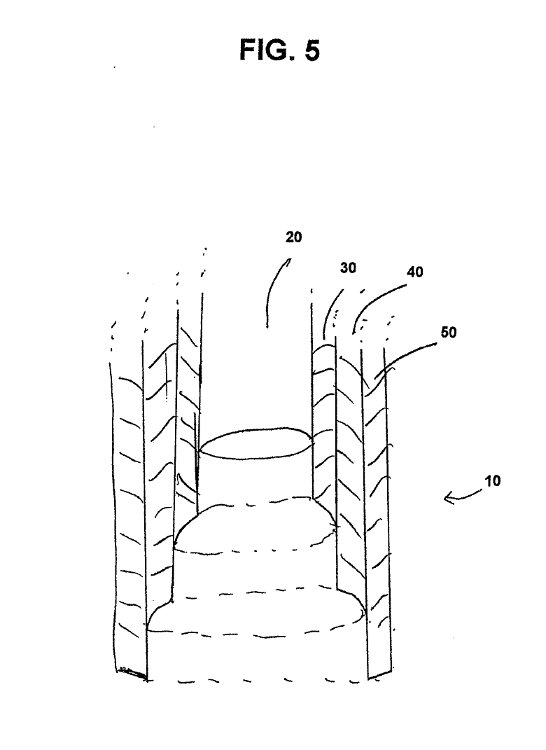

FIG. 5 depicts a cross sectional view of a power pole assembly 10 of another exemplary embodiment of the present invention. As shown in FIG. 5, a center shaft 20, a first modular support shaft 30, a second modular support shaft 40, and a third modular support shaft 50, may telescope on the interior as well as the exterior. In other words, while a length of the center shaft 20 may extend beyond the first modular support shaft 30 at a top portion of the center shaft 20, a length of the first modular support shaft may extend below the center shaft 20 at a bottom portion of the center shaft 20. By telescoping the interior of the power pole assembly at a bottom of the assembly, less material is used, reducing both weight and cost.

Additionally, in embodiments of the invention only the outermost modular support shaft may be buried below ground. In other words, rather than burying each of the center shaft and the other interior modular support shafts in the ground, only the outermost modular support shaft may be buried. Alternatively, some of the outermost modular support shafts or all of the modular support shafts may be buried in the ground, while the center shaft and optionally some interior modular support shafts may be above the ground.

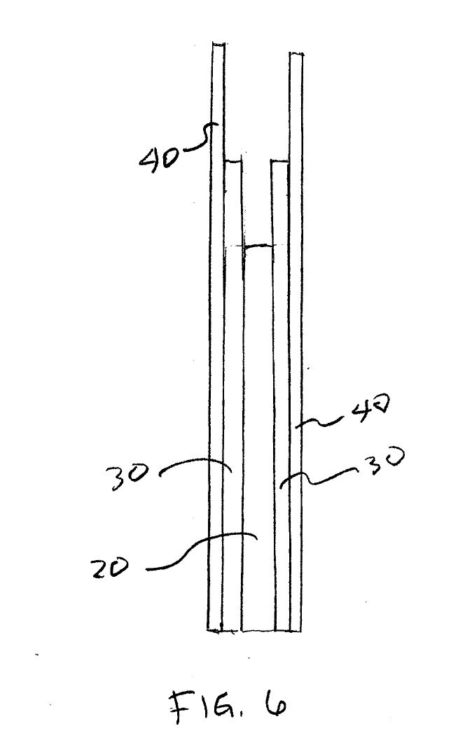

In another exemplary embodiment, as for example shown in FIG. 6, a power pole may only have interior telescoping. In other words, the length of the center shaft 20 may not extend beyond the length of the first modular support shaft 30 (i.e., the first modular support shaft 30 extends the entire length of the center shaft 20 and some additional length). Similarly, the first modular support shaft 30 may not extend beyond a length of the second modular support shaft 40 (i.e., the second modular support shaft 40 extends the entire length of the first modular support shaft 30 and some additional length). In any of the aforementioned exemplary embodiments, at least one modular support shaft may extend below the center shaft and may be embedded in the ground or other support structure.

In exemplary embodiments of the invention, the power pole assembly may be made of a non-conducting fiber reinforced composite material such as a composite of E-glass and a vinyl ester resin. Any suitable composite material may be used. Such compositions may be resistant to corrosion from the environment (i.e., wind and moisture) and the ground. Accordingly, the power pole assembly may be buried without risk of corrosion or rot. A power pole assembly made with composite materials may weigh 10 to 40 percent less than the weight of traditional wood poles, and much less than steel or concrete poles. The center shaft and each of the modular support shafts may be made of the same or different materials. Other reinforcements such as carbon fiber, high strength glass (S-Glass, R-Glass and similar), basalt fibers, aramid, etc (whether conductive or not) may be used as well to form the center shaft and/or panels. Other resin systems that may also be used may be polyester, epoxy, phenolic, urethane or thermoplastic. Additives or coatings may be used to protect from UV degradation or fire.

In exemplary embodiments of the invention, the composite materials of the power pole assembly may be formed using a pultrusion process. In the pultrusion process, continuous rolls of rovings, stranded mat and/or woven fibers are sent through a resin bath. The resin soaked fiber then proceeds through a die and heat source, which cures the resin soaked fiber in a desired shape. For example, the die may be in a circular shape to form a hollow circular center shaft. Or, the die may be in a crescent shape to form a hollow crescent shaped panel. The pultruded material is then cut into desired lengths to form a center shaft or panels.

One die may be used to make all center shafts. Then, prior to assembling a power pole assembly, the center shaft may be cut to a desired height. When a different size power pole assembly is desired, a center shaft from the same die may be formed by simply cutting the material to the desired height during or after the pultrusion process. Similarly, one die may be used to make all panels of each respective modular support shaft. In other words, because the panels of each respective modular support shaft may be the same size (i.e., each of the panels of the first modular support shaft are the same first size and each of the panels of the second modular support shaft are the same second size), one die may be used to form all the panels of a given modular support shaft. According to the needs of a particular power pole assembly, the panels may be cut to a desired height during or after the pultrusion process. If a panel of a different height is needed for a modular support shaft for a different power pole assembly, the panels may be made using the same die and then simply cut to the desired height during or after the pultrusion process. All panels required for each modular support shaft may be formed through a single die by being pultruded simultaneously. In another exemplary embodiment, the panels are pultruded sequentially. This may be accomplished by pultruding one panel at a time or by cutting each pultruded panel at a desired length during the pultrusion process or after the pultrusion process. By forming power pole assemblies according to embodiments of the present invention, less dies need to be made, as one die may be used to form the center shaft of different power pole assemblies, one die may be used to form the panels of the first modular support shaft of different power pole assemblies, and one die may be used to form the panels of the second modular support shaft of different power pole assemblies, etc.

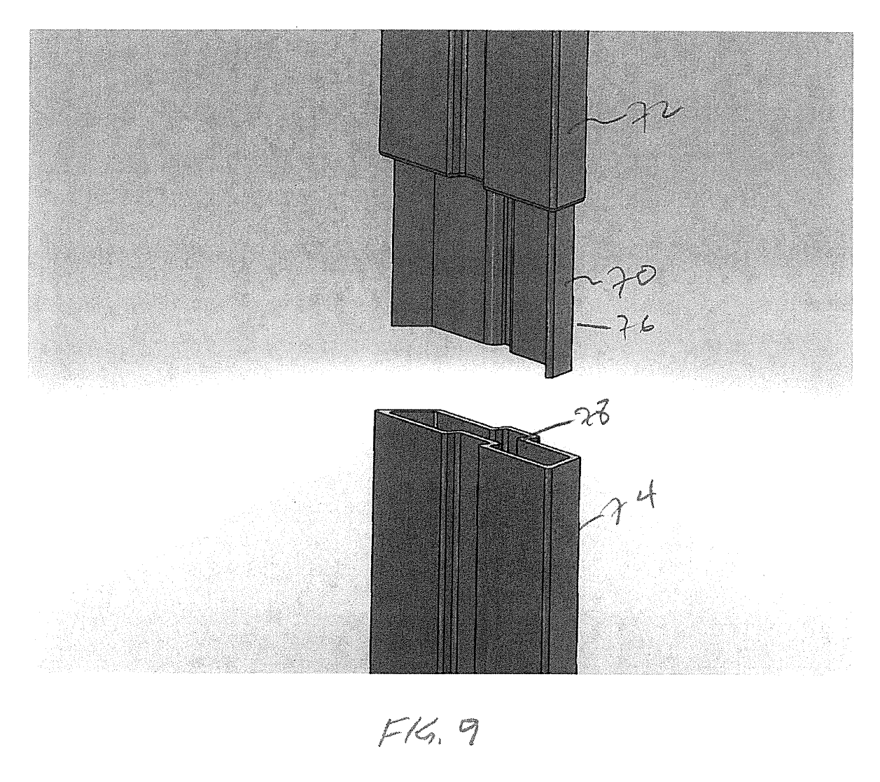

There may be situations where the length of a panel may have to be limited as for example, because it has to be shipped to a certain location for installation, and the method of shipment, whether by truck or container, may limit to the length of the panel. In such case, the panel may be made in two or more sections that can be coupled together. There are various ways that one section may be axially coupled to another section to form a single linear panel. In an exemplary embodiment, a coupling member 70 may be formed that fits inside the panel sections 72, 74 to be coupled as shown in FIG. 9. In an exemplary embodiment, the coupling member is adhered or otherwise connected to the inner surfaces of panel sections 72 and 74. In a further exemplary embodiment and as shown in FIG. 9, the coupling member has at least a surface, such a surface 76 that mates with an inner surface 78 of the panels.

Although specific embodiments of the invention have been described above, the invention may have other variations as well. The present invention has only been described by way of exemplary embodiments. Specific descriptions are not intended as limitations of the invention. The current invention also covers other embodiments within the scope of the invention but not specifically described herein.

What is claimed is:

1. A composite pole for supporting an electric transmission line comprising:
a center shaft;
a first modular support shaft surrounding the center shaft, the first modular support shaft comprising a plurality of first panels.

2. The composite pole of claim 1, wherein the center shaft has a plurality of center indentations, each of the plurality of first panels has a first protrusion on a first side and a first indentation on a second side, and the first protrusion of each of the first panels nesting with one of the center indentations.

3. The composite pole of claim 2, further comprising a second modular support shaft, the second modular support shaft surrounding less than the length of the first modular support shaft, the second support comprising a plurality of second panels, each of the plurality of second panels having a second protrusion on a first side, the second protrusion of each of said second panels nesting with the first indentation.

4. The composite pole of claim 1, wherein the first modular support shaft spans less than a length of the center shaft.

5. The composite pole of claim 4, further comprising a second modular support shaft, the second modular support shaft spanning less than a length of the first modular support shaft, the second support comprising a plurality of second panels.

6. The composite pole of claim 5, wherein the center shaft is formed from a first composite material, wherein the first modular support shaft first panels are formed from a second composite material, and wherein the second modular support shaft second panels are formed from a third composite material.

7. The composite pole of claim 5, further comprising a reinforcing layer between at least one of said plurality of first panels and at least one of said plurality of second panels.

8. The composite pole of claim 6, wherein the first, second and third composite materials are the same material.

9. The composite pole of claim 6, wherein at least one of the first, second and third composite materials is different from the other two of said first, second and third composite materials.

10. The composite pole of claim 1, wherein said first modular support shaft has a circular or elliptical outer surface when viewed in cross-section.

11. The composite pole of claim 1, wherein the center shaft is circular or elliptical when viewed in cross-section.

12. The composite pole of claim 1, wherein the center shaft is polygonal when viewed in cross-section.

13. The composite pole of claim 1, wherein the first modular support shaft spans more than a length of the center shaft.

14. The composite pole of claim 13, further comprising a second modular support shaft, the second modular support shaft spanning more than a length of the first modular support shaft, the second support comprising a plurality of second panels.

15. The composite pole of claim 14, wherein the center shaft is formed from a first composite material, wherein the first modular support shaft first panels are formed from a second composite material, and wherein the second modular support shaft second panels are formed from a third composite material.

16. The composite pole of claim 15, wherein the first, second and third composite materials are the same material.

17. The composite pole of claim 15, wherein at least one of the first, second and third composite materials is different from the other two of said first, second and third composite materials.

18. A method for forming a composite pole for supporting an electric transmission line, the method comprising:
pultruding a first composite material forming a pultruded shaft;
pultruding a second composite material forming a plurality of pultruded panels;
installing the pultruded shaft into the ground, having a section extending above ground; and
installing the plurality of panels to surround said pultruded shaft forming said composite pole.

19. The method of claim 18, wherein each of said plurality of panels has a length that is less than a length of said shaft section extending above ground.

20. The method of claim 18, wherein forming said plurality of pultruded panels comprises pultruding all of said plurality of pultruded panels simultaneously.

21. The method of claim 18, wherein forming said plurality of pultruded panels comprises pultruding said second composite material thought the same dye for forming all of said plurality of pultruded panels.

22. The method of claim 21, wherein forming said plurality of pultruded panels comprises pultruding said second composite material to form a length of pultruded material and cutting said pultruded material at appropriate intervals to form said plurality of panels.

23. The method of claim 22, wherein forming said plurality of panels comprises pultruding said second composite material and cutting said pultruded second composite material at an appropriate length to form a first of said plurality of panels.

24. The method of claim 23, further comprising:
continuing to pultrude the second composite material; and
cutting said pultruded material to form a second of said plurality of panels.

25. The method of claim 23, wherein cutting comprises cutting said pultruded second composite material proximate the dye.

26. The method of claim 18, wherein the first and second composite materials are the same.

27. The method of claim 18, wherein the first and second composite materials are different.

28. The method of claim 18, wherein pultruding comprises pultruding a hollow shaft and the method further comprises filling at least a portion of said hollow shaft with a bulking material.

29. The method of claim 18, wherein each of said plurality of panels has a length that is less than a length of said shaft section extending above ground.
